(19) United States
(12) Patent Application Publication
(10) Pub. No.: US 2026/0155612 A1
(43) Pub. Date: Jun. 4, 2026

(54) CONNECTOR ADAPTER WITH ATTACHMENT AND RETENTION FEATURES

(71) Applicant: Aptiv Technologies AG, Schaffhausen (CH)

(72) Inventors: Jeffrey MICHAEL, Austintown, OH (US); Ryan D. LEWIS, Niles, OH (US); Robert L. DEAN, New Castle, PA (US); Jared BILAS, North Bloomfield, OH (US); Joseph SUDIK, JR., Niles, OH (US); David R. PETERSON, Aurora, OH (US); Stephen VanSuch, Streetsboro, OH (US)

(21) Appl. No.: 18/964,903

(22) Filed: Dec. 2, 2024

(51) Int. Cl. H01R 13/74

(52) U.S. Cl. CPC H01R 13/743

(57) ABSTRACT

A connector adapter designed to securely hold a connector connected to an elongate conductor within an aperture in a substrate is disclosed herein. The connector adapter includes a frame with an opening to accommodate the elongate conductor, an attachment feature for fastening the frame to the substrate, and a retention feature to firmly hold the connector within the frame. This innovative connector adapter provides a reliable and efficient solution for maintaining the connection between the elongate conductor and the substrate, ensuring stability and functionality in various applications.

### TECHNICAL FIELD

The subject matter disclosed herein relates to connector adapters and, in particular, to connector adapters with attachment and retention features.

### BACKGROUND

Various approaches have been developed for temporarily securing electrical connectors attached to cables to substrates for retrieval by a robotic manipulator. One method involves the use of adhesive materials, such as tapes or fugitive glue to affix the connector to the substrate, which can be time-consuming and may not provide attachment in a known location and orientation. Another approach includes the use of mechanical fasteners such as clips to hold the connector in place, but these methods can be cumbersome and may require additional tools for installation. Additionally, some existing connector adapters utilize complex locking mechanisms or clamps to retain the connector to the substrate, which can be difficult to operate and may not provide sufficient stability.

Overall, the existing approaches for retaining electrical connectors within apertures in substrates have various limitations in terms of ease of installation, security of attachment, and positioning and alignment. However, none of these approaches have provided a comprehensive solution that combines the features described in this disclosure.

### SUMMARY

In some aspects, the techniques described herein relate to a connector adapter configured to retain a connector attached to an end of an elongate conductor within an aperture defined in a substrate. The connector adapter includes a frame defining an opening configured to receive the elongate conductor, an attachment feature configured to secure the frame to the substrate, and a retention feature configured to secure the connector within the frame.

### BRIEF DESCRIPTION OF THE DRAWINGS

FIG. 1 is an isometric view of a wiring channel with a connector adapter retaining an electrical connector of a wiring harness disposed within an opening in a peripheral wall of the wiring channel according to some embodiments.

FIG. 2 is an isometric view of a robotic manipulator attaching a mating electrical connector to the electrical connector retained within the connector adapter of FIG. 1 according to some embodiments.

FIG. 3 is an isometric view of the electrical connector retained within the connector adapter of FIG. 1 without the wiring channel according to some embodiments.

FIG. 4 is an isometric view of the connector adapter of FIG. 1 according to some embodiments.

FIG. 5 is a close-up isometric view of a connector retention device of the connector adapter of FIG. 4 according to some embodiments.

FIG. 6 is an isometric view of the connector adapter of FIG. 3 disassembled into two separate parts according to some embodiments.

FIG. 7 is an isometric view of a wiring channel with a connector adapter retaining an electrical connector of a wiring harness within an opening in a peripheral wall of the wiring channel according to some other embodiments.

FIG. 8 is an isometric view of a robotic manipulator attaching a mating electrical connector to the electrical connector retained within the connector adapter of FIG. 7 according to some other embodiments.

FIG. 9 is a side view of the electrical connector retained within the connector adapter of FIG. 7 without the wiring channel according to the other embodiments.

FIG. 10 is a close-up isometric view of a connector retention device of the connector adapter of FIG. 7 according to the other embodiments.

FIG. 11 is an isometric view of a wiring channel with a connector adapter retaining a female electrical connector of a wiring harness disposed within an opening in an end wall of the wiring channel according to some embodiments.

FIG. 12 is an isometric view of a wiring channel with a connector adapter retaining a male electrical connector of a wiring harness within an opening in an end wall of the wiring channel according to some other embodiments.

### DETAILED DESCRIPTION

A connector adapter configured for retaining an electrical connector of a wiring harness to a wiring channel in which the wiring harness is disposed is presented herein. The connector adapter is configured to facilitate robotic connection of the electrical connector to a mating connector. The connector adapter allows multiple types of inline connections to be housed in a common wiring harness channel/module to facilitate easier positioning and mating of electrical connector for automatic/robotic assembly. The connectors of a wiring harness are positioned in a connector adapter consisting of one or multiple pieces that allow for variability of the connector's size. The connector adapter may be configured to retain either male or female connectors using a clip slot and/or similar features. This connector adapter includes a feature that positions the connector within the aperture as well as a feature to resist the plugging force of the robotic end effector. This connector adapter may contain multiple connectors.

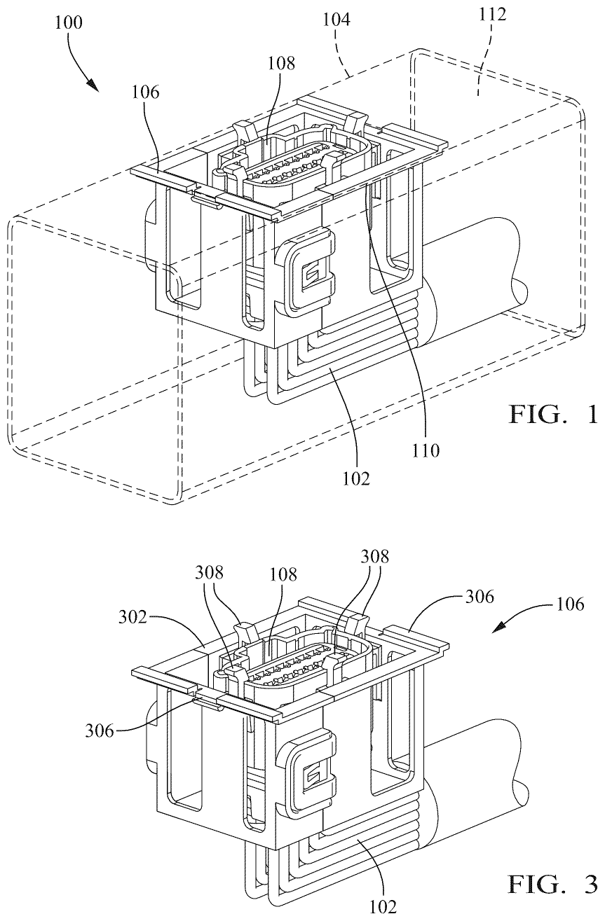

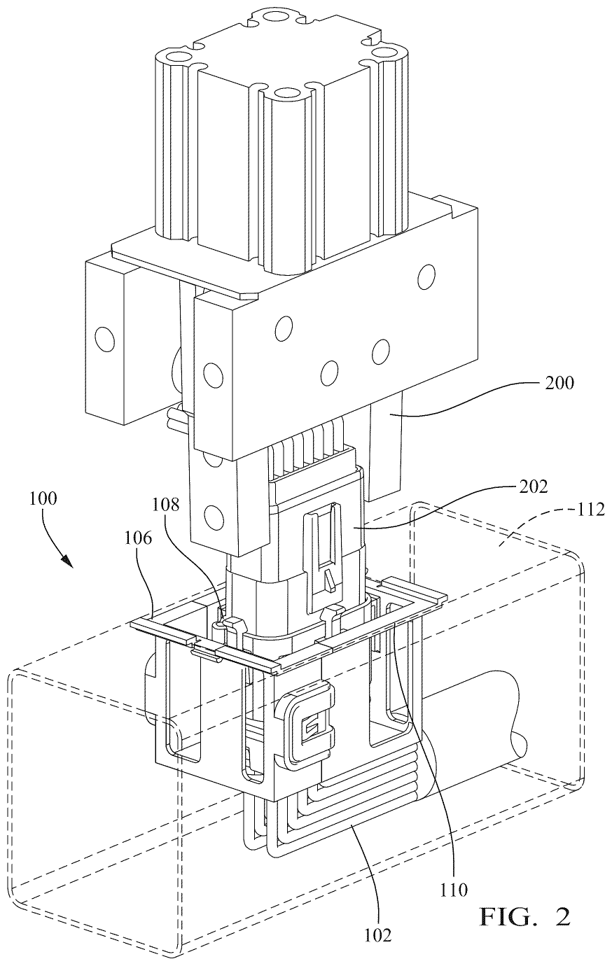

FIG. 1 is an isometric view of a wiring assembly 100 that includes a wiring harness 102 within a wiring channel 104 of the wiring assembly 100. The wiring channel 104, also known as a cable raceway, is used to protect the wiring harness 102 and provide a preferred routing for the wiring harness 102. The wiring channel 104 may also enhance robotic manipulation and handling of the wiring assembly 100. The wiring assembly 100 further includes a connector adapter 106 retaining an electrical connector 108 of the wiring harness 102 in an opening or aperture 110 in a peripheral wall 112 of the wiring channel 104. In the illustrated example, the electrical connector 108 is a female electrical connector. The connector adapter 106 further enhances robotic manipulation and placement of the wiring assembly 100 by maintaining the electrical connector 108 in a predetermined known location and orientation on the wiring assembly 100 to assist a robotic manipulator 200 with coupling a corresponding mating electrical connector 202 of another wiring assembly, or of an electronic module, to the electrical connector 108 as shown in FIG. 2. In the illustrated example, the mating electrical connector 202 is a male electrical connector.

FIG. 3 shows the wiring harness 102, the connector adapter 106, and the electrical connector 108 removed from the wiring channel 104. As can be seen in FIG. 3, the connector adapter 106 has a frame 302 which forms an opening in which a portion of the wiring harness 102 is received. The frame 302 is preferably formed of a dielectric material, such as a polyamide (NYLON) or polybutylene terephthalate (PBT). The frame 302 also includes an attachment feature 306 configured to secure the frame 302 to the peripheral wall 112 within the aperture 110 in the wiring channel 104 and a retention feature 308 configured to secure the electrical connector 108 within the frame 302. The attachment feature 306 may be configured to attached the frame 302 within an aperture 110 in any other substrate, e.g. a panel, a module housing, etc.

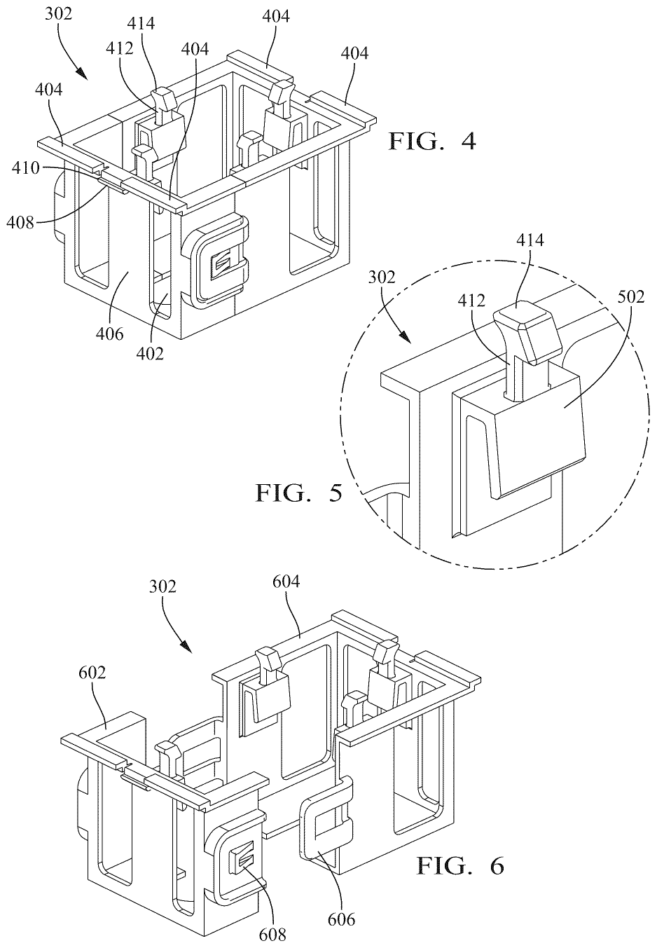

FIG. 4 shows an isolated view of the connector adapter 106 in which the opening 402 may more clearly be seen. The attachment feature 306 includes a lip 404 extending from a side wall 406 of the frame 302. This lip 404 is configured to overlap an outer surface of the peripheral wall 112 of the wiring channel 104. The attachment feature 306 additionally includes a ramped snap lock 408 which extends from the side wall 406 and is separated from the lip 404 by a gap 410 in which an edge of the peripheral wall 112 formed by the aperture 110 is configured to be received. The snap lock 408 is configured to engage an inner surface of the peripheral wall 112 opposite the outer surface. The side wall 406 is resilient and configured to flex inwardly as the snap lock 408 passes through the opening, thereby allowing the edge of the peripheral wall 112 to bypass the snap lock 408 and enter the gap 410. The lip 404 and the snap lock 408 may be integrally formed with the frame 302 and are configured to cooperate to secure the frame 302 to the peripheral wall 112 of the wiring channel 104.

As shown in FIG. 4, the retention feature 308 includes a plurality of latching arms 412 that are configured to engage edges of the electrical connector 108 as illustrated in FIG. 3. The latching arms 412 are cantilevered and free ends of the latching arms define angled latches 414 which push back the resilient latching arms 412 as the electrical connector 108 is inserted between the latching arms 412 which snap back to retain the electrical connector 108 within the connector adapter 106. The latching arms 412 are integrally formed with the frame 302. The angled latches 414 may be pried back to release the electrical connector 108 within the connector adapter 106, e.g., for servicing the electrical connector 108.

FIG. 5 further illustrates that the latching arms 412 including resilient spring features 502 in the form of cantilevered plates that are configured to center the electrical connector 108 between the latching arms 412.

FIG. 6 shows that the frame 302 has a first frame portion 602 that is configured to attached to and detachable from a second frame portion 604. The first frame portion 602 in the illustrated example is attached to the second frame portion 604 by flexible loops 606 in which latches 608 are received. Other embodiments may be envisioned in which other means are employed to releasably or permanently attach the first frame portion 602 to the second frame portion 604. The first frame portion 602 defines a first portion of the opening 402 and the second frame portion 604 defines a second portion of the opening 402. The first frame portion 602 is configured to be attached to one of a plurality of second frame portions having different lengths in order to accommodate different electrical connectors of varying lengths, for example electrical connectors having the same number of rows of terminals but differing numbers of columns of terminals.

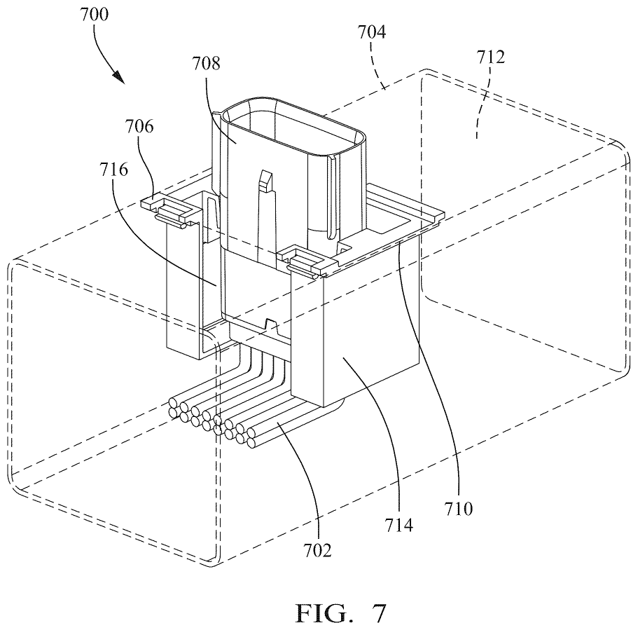

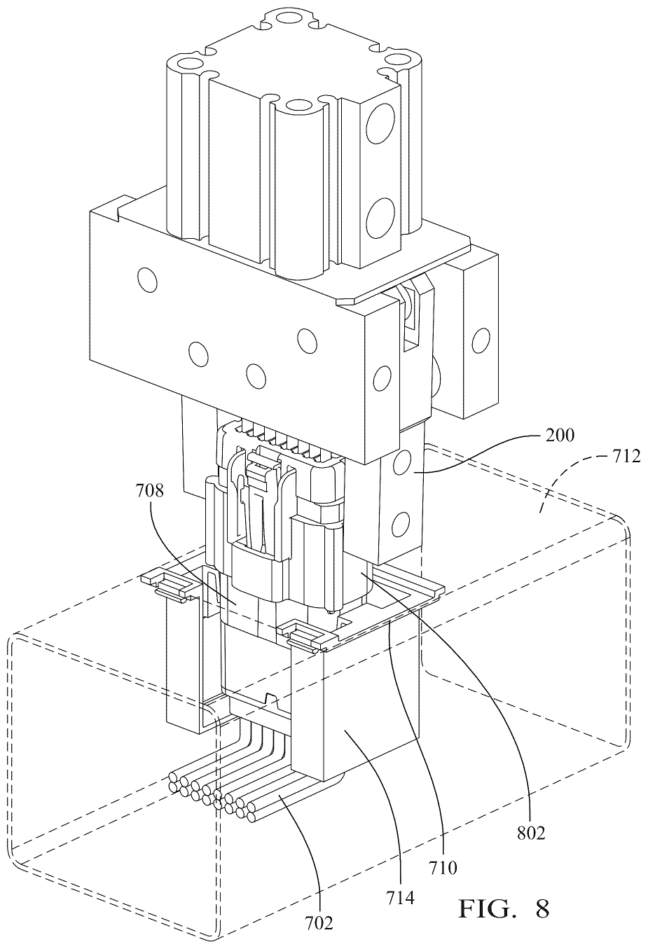

FIG. 7 is an isometric view of another wiring assembly 700 that includes a wiring harness 702 within a wiring channel 704 of the wiring assembly 100. Like the wiring channel 104, the wiring channel 704 is used to protect and route the wiring harness 702 in addition to enhancing robotic manipulation and handling of the wiring assembly 700. The wiring assembly 700 further includes a connector adapter 706 retaining an electrical connector 708 of the wiring harness 702 in an opening or aperture 710 in a peripheral wall 712 of the wiring channel 704. In the illustrated example, the electrical connector 708 is a male electrical connector. The connector adapter 706 further enhances robotic manipulation and placement of the wiring assembly 700 by maintaining the electrical connector 708 in a predetermined known location and orientation on the wiring assembly 700 to assist the robotic manipulator 200 with coupling a corresponding mating electrical connector 802 of another wiring assembly, or of an electronic module, to the electrical connector 708 as shown in FIG. 8. In the illustrated example, the mating electrical connector 802 is a female electrical connector.

As further shown in FIG. 7, the connector adapter 706 has a frame 714 which forms an opening 716 in which a portion of the wiring harness 702 is received. The frame 714 is preferably formed of a dielectric material, such as a polyamide (NYLON) or polybutylene terephthalate (PBT).

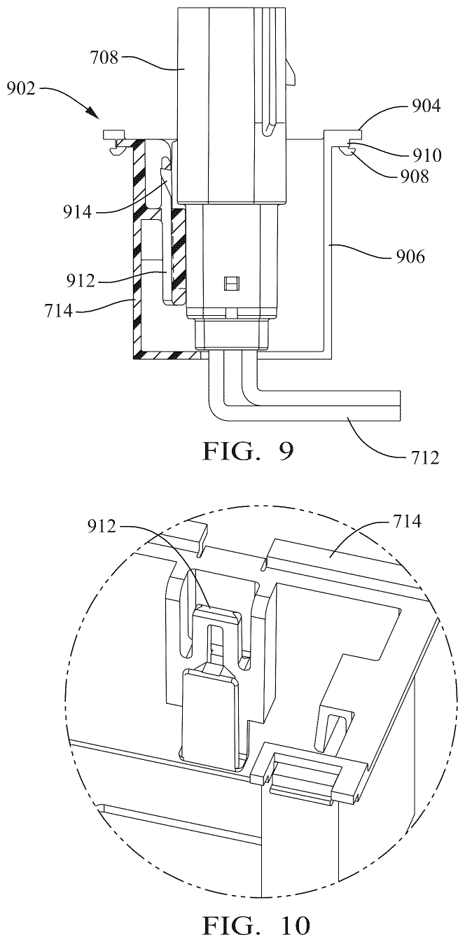

Focusing now to FIG. 9, the frame 714 also includes an attachment feature 902 configured to secure the frame 714 to the peripheral wall 712 within the aperture 710 in the wiring channel 704. The attachment feature 306 may be configured to attached the frame 302 within an aperture in any other substrate, e.g. a panel, a module housing, etc. The attachment feature 902 includes a lip 904 extending from a side wall 906 of the frame 714. This lip 904 is configured to overlap an outer surface of the peripheral wall 712 of the wiring channel 704. The attachment feature 902 additionally includes a ramped snap lock 908 which extends from the side wall 906 and is separated from the lip 904 by a gap 910 in which an edge of the peripheral wall 712 formed by the aperture 710 is configured to be received. The snap lock 908 is configured to engage an inner surface of the peripheral wall 712 opposite the outer surface. The side wall 906 is resilient and configured to flex inwardly as the snap lock 908 passes through the aperture 710, thereby allowing the edge of the peripheral wall 712 to bypass the snap lock 908 and enter the gap 910. The lip 904 and the snap lock 908 may be integrally formed with the frame 714 and are configured to cooperate to secure the frame 714 to the peripheral wall 712 of the wiring channel 704.

The frame 714 also includes a retention feature 912 shown in FIGS. 9 and 10 that is configured to engage with a mounting clip 914 on the electrical connector 708. For example, the mounting clip 914 on the electrical connector 708 may be compliant with USCAR Specification EWCAP-005 Rev. G and part of an existing design of the electrical connector 708 which may be used to attach the electrical connector 708 to other features, e.g., fir tree fasteners.

Other embodiments of the frames 302 and 714 may be envisioned in which the frame 302 includes the retention feature 912 or the frame 714 includes the retention feature 308.

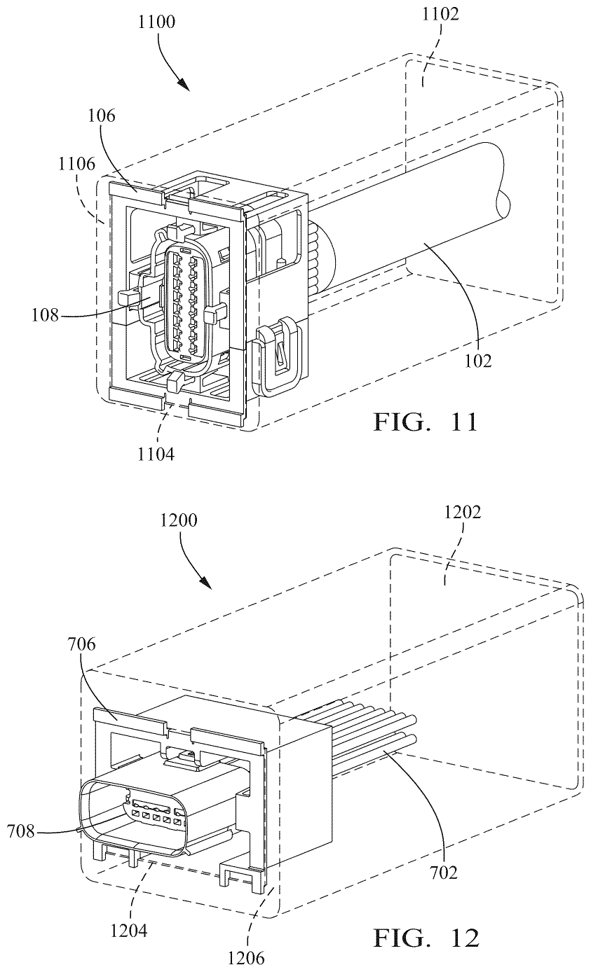

FIG. 11 illustrates another wiring assembly 1100 having a wiring channel 1102 with an aperture 1104 defined in an end wall 1106 of the wiring channel 1102. Wiring harness 102 is disposed within the wiring channel 1102 and the connector adapter 106 is disposed within the aperture 1104 to secure the electrical connector 108 of the wiring harness 102 within the aperture 1104.

FIG. 12 illustrates yet another wiring assembly 1200 having a wiring channel 1202 with an aperture 1204 defined in an end wall 1206 of the wiring channel 1202. Wiring harness 702 is disposed within the wiring channel 1102 and the connector adapter 706 is disposed within the aperture 1104 to secure the electrical connector 708 of the wiring harness 702 within the aperture 1104.

The placement of the electrical connectors 108 and 708 in the end walls of the wiring assemblies 1100 and 1200 allow these wiring assemblies 1100, 1200 to be connected end to end which may simplify robotic installation of long wiring harnesses.

While the examples illustrated herein are directed to a connector adapter for an electrical connector, alternative embodiments may be envisioned that are directed to a connector adapter for fiber optic connectors, pneumatic connectors, hydraulic connectors, or hybrid connectors containing a combination of any of these types of conductors.

### DISCUSSION OF POSSIBLE EMBODIMENTS

The following are non-exclusive descriptions of possible embodiments of the present invention.

In some aspects, the techniques described herein relate to a connector adapter configured to retain a connector attached to an end of an elongate conductor within an aperture defined in a substrate. The connector adapter includes a frame defining an opening configured to receive the elongate conductor, an attachment feature configured to secure the frame to the substrate, and a retention feature configured to secure the connector within the frame.

The connector adapter of the preceding paragraph can optionally include, additionally and/or alternatively any, one or more of the following features/steps, configurations and/or additional components.

In some aspects, the techniques described herein relate to a connector adapter, wherein the attachment feature is configured to secure the connector adapter within an aperture defined in the substrate. The connector adapter includes a lip extending from a side wall of the frame and configured to overlap a first surface of the substrate and a snap lock extending from the side wall and separated from the lip by a gap in which an edge of the aperture is configured to be received. The snap lock is configured to engage a second surface of the substrate opposite the first surface. The lip and the snap lock are configured to cooperate to secure the frame to the substrate.

In some aspects, the techniques described herein relate to a connector adapter, wherein the side wall is resilient and configured to allow the edge of the aperture to bypass the snap lock and enter the gap.

In some aspects, the techniques described herein relate to a connector adapter, wherein the retention feature is configured to interface with a mounting clip.

In some aspects, the techniques described herein relate to a connector adapter, wherein the mounting clip is compliant with USCAR Specification EWCAP-005 Rev. G.

In some aspects, the techniques described herein relate to a connector adapter, wherein the retention feature includes a plurality of latching arms configured to engage an edge of the connector.

In some aspects, the techniques described herein relate to a connector adapter, wherein the plurality of latching arms is resilient and configured to releasably retain the connector within the connector adapter.

In some aspects, the techniques described herein relate to a connector adapter, wherein the plurality of latching arms further include resilient spring features configured to center the connector between the plurality of latching arms.

In some aspects, the techniques described herein relate to a connector adapter, wherein resilient spring features are cantilevered angled plates projecting from the plurality of latching arms.

In some aspects, the techniques described herein relate to a connector adapter, wherein the frame includes a first frame portion configured to be attached to and detachable from a second frame portion.

In some aspects, the techniques described herein relate to a connector adapter, wherein the first frame portion defines a first portion of the opening and wherein the second frame portion defines a second portion of the opening.

In some aspects, the techniques described herein relate to a connector adapter, wherein the first frame portion is configured to be attached to one of a plurality of second frame portions having different lengths.

In some aspects, the techniques described herein relate to a connector adapter, wherein the frame is integrally formed.

In some aspects, the techniques described herein relate to a connector adapter, wherein the opening is defined by two adjacent outer walls of the frame arranged substantially perpendicular to one another.

In some aspects, the techniques described herein relate to a connector adapter, wherein the connector is an electrical connector and the elongate conductor in an electrical cable and wherein the electrical connector is disposed within the connector adapter.

In some aspects, the techniques described herein relate to a connector adapter, further including the substrate, wherein the connector adapter is disposed within the aperture in the substrate.

In some aspects, the techniques described herein relate to a connector adapter, wherein the substrate includes a wiring routing channel in which the electrical cable is disposed.

In some aspects, the techniques described herein relate to a connector adapter, wherein the substrate includes an elongate peripheral wall of the wiring routing channel and wherein the aperture is defined by the elongate peripheral wall of the wiring routing channel.

In some aspects, the techniques described herein relate to a connector adapter, wherein the substrate includes an end wall of the wiring routing channel and wherein the aperture is defined by the end wall of the wiring routing channel.

In some aspects, the techniques described herein relate to a connector adapter, wherein the electrical connector is coupled with a corresponding mating connector of an interfacing electrical device.

While an exemplary embodiment(s) has been described, it will be understood by those skilled in the art that various changes may be made, and equivalents may be substituted for elements thereof without departing from the scope of the claims. In addition, many modifications may be made to adapt a particular situation or material to the teachings of this disclosure without departing from the essential scope thereof. Therefore, it is intended that the claims are not limited to the disclosed embodiment(s) but include all embodiments falling within the scope of the following claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### CLAUSES

Clause 1. A connector adapter (106, 706) configured to retain a connector attached to an end of an elongate conductor within an aperture (110, 710) defined in a substrate, said connector adapter (106, 706) comprising: a frame (302, 714) defining an opening (402, 716) configured to receive the elongate conductor; an attachment feature (306, 902) configured to secure the frame (302, 714) to the substrate; and a retention feature (308, 912) configured to secure the connector within the frame (302, 714).
Clause 2. The connector adapter (106, 706) in accordance with clause 1, said attachment feature (306, 902) being configured to secure the connector adapter (106, 706) within the aperture (110, 710) defined in the substrate, said connector adapter (106, 706) comprising: a lip (404, 904) extending from a side wall (406, 906) of the frame (302, 714) and configured to overlap a first surface of the substrate; and a snap lock (408, 908) extending from the side wall (406, 906) and separated from the lip (404, 904) by a gap (410, 910) in which an edge of the aperture (110, 710) is configured to be received, wherein the snap lock (408, 908) is configured to engage a second surface of the substrate opposite the first surface and wherein the lip (404, 904) and the snap lock (408, 908) are configured to cooperate to secure the frame (302, 714) to the substrate.
Clause 3. The connector adapter (106, 706) in accordance with clause 2, wherein the side wall (406, 906) is resilient and configured to allow the edge of the aperture (110, 710) to bypass the snap lock (408, 908) and enter the gap (410, 910).
Clause 4. The connector adapter (106, 706) in accordance with clause 1, wherein the retention feature (308, 912) is configured to interface with a mounting clip (914).
Clause 5. The connector adapter (106, 706) in accordance with clause 4, wherein the mounting clip (914) is compliant with USCAR Specification EWCAP-005 Rev. G.
Clause 6. The connector adapter (106, 706) in accordance with clause 1, wherein the retention feature (308, 912) comprises a plurality of latching arms (412) configured to engage an edge of the connector.
Clause 7. The connector adapter (106, 706) in accordance with clause 6, wherein the plurality of latching arms (412) is resilient and configured to releasably retain the connector within the connector adapter (106, 706).
Clause 8. The connector adapter (106, 706) in accordance with clause 6, wherein the plurality of latching arms (412) further comprise resilient spring features (502) configured to center the connector between the plurality of latching arms (412).
Clause 9. The connector adapter (106, 706) in accordance with clause 8, wherein resilient spring features (502) are cantilevered angled plates projecting from the plurality of latching arms (412).
Clause 10. The connector adapter (106, 706) in accordance with clause 1, wherein the frame (302, 714) comprises a first frame portion (602) configured to be attached to and detachable from a second frame portion (604).
Clause 11. The connector adapter (106, 706) in accordance with clause 10, wherein the first frame portion (602) defines a first portion of the opening (402, 716) and wherein the second frame portion (604) defines a second portion of the opening (402, 716).
Clause 12. The connector adapter (106, 706) in accordance with clause 10, wherein the first frame portion (602) is configured to be attached to one of a plurality of second frame portions (604) having different lengths.
Clause 13. The connector adapter (106, 706) in accordance with clause 1, wherein the frame (302, 714) is integrally formed.
Clause 14. The connector adapter (106, 706) in accordance with clause 13, wherein the opening (402, 716) is defined by two adjacent outer walls of the frame (302, 714) arranged substantially perpendicular to one another.
Clause 15. The connector adapter (106, 706) in accordance with clause 1, wherein the connector is an electrical connector (108, 708) and the elongate conductor in an electrical cable and wherein the electrical connector (108, 708) is disposed within the connector adapter (106, 706).
Clause 16. The connector adapter (106, 706) in accordance with clause 15, further comprising the substrate, wherein the connector adapter (106, 706) is disposed within the aperture (110, 710) in the substrate.
Clause 17. The connector adapter (106, 706) in accordance with clause 16, wherein the substrate comprises a wiring routing channel in which the electrical cable is disposed.
Clause 18. The connector adapter (106, 706) in accordance with clause 17, wherein the substrate comprises an elongate peripheral wall (112, 712) of the wiring routing channel and wherein the aperture (110, 710) is defined by the elongate peripheral wall (112, 712) of the wiring routing channel.
Clause 19. The connector adapter (106, 706) in accordance with clause 17, wherein the substrate comprises an end wall (1106, 1206) of the wiring routing channel and wherein the aperture (110, 710) is defined by the end wall (1106, 1206) of the wiring routing channel.
Clause 20. The connector adapter (106, 706) in accordance with clause 15, wherein the electrical connector (108, 708) is coupled with a corresponding mating connector of an interfacing electrical device.

1. A connector adapter configured to retain a connector attached to an end of an elongate conductor within an aperture defined in a substrate, said connector adapter comprising:
a frame defining an opening configured to receive the elongate conductor;
an attachment feature configured to secure the frame to the substrate; and
a retention feature configured to secure the connector within the frame.

2. The connector adapter in accordance with claim 1, said attachment feature being configured to secure the connector adapter within an aperture defined in the substrate, said connector adapter comprising:
a lip extending from a side wall of the frame and configured to overlap a first surface of the substrate; and
a snap lock extending from the side wall and separated from the lip by a gap in which an edge of the aperture is configured to be received, wherein the snap lock is configured to engage a second surface of the substrate opposite the first surface and wherein the lip and the snap lock are configured to cooperate to secure the frame to the substrate.

3. The connector adapter in accordance with claim 2, wherein the side wall is resilient and configured to allow the edge of the aperture to bypass the snap lock and enter the gap.

4. The connector adapter in accordance with claim 1, wherein the retention feature is configured to interface with a mounting clip.

5. The connector adapter in accordance with claim 4, wherein the mounting clip is compliant with USCAR Specification EWCAP-005 Rev. G.

6. The connector adapter in accordance with claim 1, wherein the retention feature comprises a plurality of latching arms configured to engage an edge of the connector.

7. The connector adapter in accordance with claim 6, wherein the plurality of latching arms is resilient and configured to releasably retain the connector within the connector adapter.

8. The connector adapter in accordance with claim 6, wherein the plurality of latching arms further comprise resilient spring features configured to center the connector between the plurality of latching arms.

9. The connector adapter in accordance with claim 8, wherein resilient spring features are cantilevered angled plates projecting from the plurality of latching arms.

10. The connector adapter in accordance with claim 1, wherein the frame comprises a first frame portion configured to be attached to and detachable from a second frame portion.

11. The connector adapter in accordance with claim 10, wherein the first frame portion defines a first portion of the opening and wherein the second frame portion defines a second portion of the opening.

12. The connector adapter in accordance with claim 10, wherein the first frame portion is configured to be attached to one of a plurality of second frame portions having different lengths.

13. The connector adapter in accordance with claim 1, wherein the frame is integrally formed.

14. The connector adapter in accordance with claim 13, wherein the opening is defined by two adjacent outer walls of the frame arranged substantially perpendicular to one another.

15. The connector adapter in accordance with claim 1, wherein the connector is an electrical connector and the elongate conductor in an electrical cable and wherein the electrical connector is disposed within the connector adapter.

16. The connector adapter in accordance with claim 15, further comprising the substrate, wherein the connector adapter is disposed within the aperture in the substrate.

17. The connector adapter in accordance with claim 16, wherein the substrate comprises a wiring routing channel in which the electrical cable is disposed.

18. The connector adapter in accordance with claim 17, wherein the substrate comprises an elongate peripheral wall of the wiring routing channel and wherein the aperture is defined by the elongate peripheral wall of the wiring routing channel.

19. The connector adapter in accordance with claim 17, wherein the substrate comprises an end wall of the wiring routing channel and wherein the aperture is defined by the end wall of the wiring routing channel.

20. The connector adapter in accordance with claim 15, wherein the electrical connector is coupled with a corresponding mating connector of an interfacing electrical device.
